(19) United States
(12) Patent Application Publication
(10) Pub. No.: US 2010/0001532 A1
(43) Pub. Date: Jan. 7, 2010

(54) WIND-DRIVEN TURBINE CELLS AND ARRAYS

(76) Inventor: Mihai Grumazescu, Winnipeg (CA)

Correspondence Address: ADE & COMPANY INC., 2157 Henderson Highway, WINNIPEG, MB, R2G1P9, CA

(21) Appl. No.: 12/303,373

(22) PCT Filed: Jun. 4, 2007
(86) PCT No.: PCT/CA2007/000978

§ 371 Date: May 19, 2009

Related U.S. Application Data
(60) Provisional application No. 60/812,607, filed on Jun. 12, 2006.

(51) Int. Cl. F03D 9/00; F03D 1/02

(52) U.S. Cl. 290/55; 415/60

(57) ABSTRACT

An electrical energy generating system is mounted on a structure and includes a ducted shroud facing the wind and concentrating its flow through Coanda effect to inlet mouths each directed to a respective one of a plurality of small centrifugal or axial turbines connected to brushless DC generators. The air exits each turbine axially and is directed to flow along the wall, merging with the natural vertical airflow and is discarded at the top of the structure where another deflector creates a negative pressure helping the residual airflow to merge with wind blowing over the top. The efficiency of generation is proportional to the difference between the front wind pressure and the back air pressure. While each wind cell generates only a few tens of watts, the array can generate a large amount of electricity to be used for the structure and/or to be made available to a grid.

This invention relates to an apparatus for generating electrical energy from wind and to the mounting of such an apparatus on a suitable structure such as a building, an upstanding fixed structure such as a billboard, oil and gas platforms, cliffs or chimneys and on movable structures such as ship deck structures and airships.

### BACKGROUND OF THE INVENTION

This invention relates mainly to the urban wind power field in which there are two known approaches. The first is the concept of roof mounted wind turbines, either vertical or horizontal axis, and the second is that of horizontal axis turbines fully integrated into the building fabric. The roof mounted turbines can be from large to micro diameters and have the advantage of being self wind-oriented while the integrated turbines are only very large and with a fixed position which is compensated by shaping the building like a boomerang that accelerates airflow over the turbine.

The main drawback of the prior art is the level of noise and vibration produced by a large turbine. The noise due to air friction on blades can be reduced by lowering the rotational speed. However, any imbalance shows up once per revolution and there is nothing you can do about it. A large turbine can turn a roof into a loudspeaker and the building itself can also vibrate, amplifying the sound. Other disadvantages are related to how bad a roof mounted turbine looks or the cost of designing and raising a building structure for the integrated turbines.

U.S. Pat. No. 4,220,870 of Kelly teaches a wind conversion lattice array featuring multiple miniature turbine wind generator modules mounted on a lattice-like framework on a building rooftop or other suitable raised structure. Each module features a multi-vaned turbine impeller directly coupled to a DC electric generator. Kelly does not teach mounting the array on the exterior wall of the building and also does not teach ducted shrouding to concentrate moving air against a particular part of each turbine. Instead, Kelly's turbines are supported in open air above the roof and rely on shaped vanes to induce rotation of each turbine in a predetermined direction. Kelly does not teach the provision of any guide surfaces for controlling inlet and outlet air. Kelly teaches arraying a plurality of small wind generator modules in a vertical plane.

U.S. Pat. No. 5,394,016 of Hickey teaches a solar and wind energy generating system for mounting to a building having wind generators with vanes rotatable by wind blowing along the buildings walls. The generators are stored within the building when not in use and extend outward from the building walls during operation. Hickey also teaches an auger-shaped member disposed in a channel traversing the building between floors. Wind that would normally blow against the exterior wall passes through the channel and rotates the auger-shaped member. A deflector can be used to direct airflow associated with the auger-shaped member. While Hickey makes use of air that normally would blow against the exterior wall, the building-traversing channels require extensive modification to the building and clearly cannot be easily arrayed over the exterior wall.

U.S. Pat. No. 4,004,427 of Butler, Jr. teaches an energy conversion system for a building. The system includes radiation receiving surfaces supported adjacent but spaced from exterior walls of the building, thereby defining a flow-way between the surfaces and the walls. A ducting apparatus redirects air from the flow-way to a rotor mounted on top of the building to drive rotation thereof. Butler, Jr. teaches the redirection of air to drive a single large rotor. Butler, Jr. also teaches vertical strings of wind wheels disposed at corners of the building for converting wind energy.

U.S. Pat. No. 6,836,028 of Northrup teaches, in a massive system, converging the air into a smaller opening to drive a generator.

U.S. Pat. No. 4,146,800 by Gregory et al. teaches a method of producing electricity from wind energy without the use of a rotational member as found in conventional generating methods. The method involves producing an electrostatic field through which wind can blow and introducing charged particles into the wind to be carried thereby through the field against electrostatic forces therein to cause an increase in potential energy.

U.S. Pat. No. 5,347,186 by Konotchick teaches a linear motion electric generator using the same principle of inducing electricity into a coil through the movement of a magnet therethrough. However, Konotchick does not appear to disclose a way to harness wind for electrical generation using this process, as his patent is clearly limited to the use of intermittent drive sources for providing oscillation.

### SUMMARY OF THE INVENTION

It is one object of the invention to provide an apparatus for generating electrical energy from wind.

According to one aspect of the invention there is provided an apparatus for generating electrical energy from wind comprising:

an array of cells each arranged for generating electricity from wind;

each cell having wind guide surfaces for directing incoming wind through a mouth;

each cell having a movable element responsive to movement of the wind through the mouth arranged such that movement of the movable element generates electricity;

the cells being connected in the array side by side such that the guide surfaces present a front face for presentation to the wind with the movable elements behind the front face;

the array being arranged for mounting on an upstanding structure.

In one preferred arrangement, each cell is arranged to release residual air in a direction transverse to the incoming direction so as to be directed along a front face of the upstanding structure.

Preferably the guide surfaces of each cell interconnect with guide surfaces of next adjacent cells to present a front face of the surfaces between the cells.

In one preferred arrangement, the apparatus is arranged to be directly mounted on one or more exterior walls of a high building. However the arrangement can also be used in other structures as described hereinafter.

Preferably the guide surfaces form a ducted shroud facing the wind and concentrating its flow to each of the cells.

Preferably the guide surfaces are arranged to direct the wind through Coanda effect.

In one preferred arrangement, each of the cells comprises a small centrifugal turbine. However, a number of alternative arrangements for generating electrical energy from the air flowing through the mouth can be provided as will be well known to one skilled in this art.

In this arrangement, the turbine is preferably connected to a brushless DC generator.

In this arrangement, after driving rotation of the turbines, the residual air preferably exits each turbine axially and flows along a front face of the structure.

In this arrangement, the apparatus preferably includes guides for the residual air to cause it to flow upward, or in another common direction, along the wall.

In this arrangement, the guides for the residual air are preferably arranged to receive the air from a plurality of the cells arranged in a row.

In this arrangement, the residual air is preferably discarded at the top edge of the structure. However the guides and the turbines may be oriented such that another location is selected for the discharge of the residual air.

Preferably a top deflector is shaped to receive upwardly moving air and to redirect it into a horizontal flow over a top of the structure.

Preferably the top deflector is shaped to create a negative pressure helping the residual airflow to gather the wind blowing over the top of the structure.

In this arrangement, each wind cell generates only a few tens of watts which energy is connected from a whole array of cells covering the windward walls of a structure to generate a large amount of electricity to be used for cutting the energy costs of that structure and/or to be made available to a broader energy grid.

According to a second aspect of the invention there is provided an apparatus for generating electrical energy from wind comprising:

a structure having an upstanding face directed toward a prevailing wind;

an array of cells each arranged for generating electricity from wind;

each cell having wind guide surfaces for directing incoming wind through a mouth;

each cell having a movable element responsive to movement of the wind through the mouth arranged such that movement of the movable element generates electricity;

the array being mounted on the upstanding face of upstanding structure;

the cells being arranged such that movement of the movable element causes generation of a residual airflow at a velocity and pressure less than that of the incoming wind with the residual airflow being released in front of the face of the structure and behind the guide surfaces so as to reduce a pressure on the face from the incoming air.

According to a third aspect of the invention there is provided an apparatus for generating electrical energy from wind comprising:

an array of cells each arranged for generating electricity from wind;

each cell having wind guide surfaces for directing incoming wind through a mouth;

the cells being arranged such that the mouths of all the cells lie generally in a common plane so as to present a common face to the wind;

each cell having a small, centrifugal, generally cylindrical turbine responsive to movement of the wind through the mouth to drive the turbine about its axis and connected to a DC generator to generate electricity;

wherein the turbines are mounted with their axes of rotation generally parallel to the plane of the mouths and offset to one side of the mouth such that the wind passing through the mouth enters into the generally cylindrical turbine while generating a rotational force on the turbine and exits the turbine in a generally axial direction.

According to a fourth aspect of the invention there is provided an apparatus for generating electrical energy from wind comprising:

an upstanding structure having an upstanding face directed toward a prevailing wind;

an array of cells each arranged for generating electricity from wind;

each cell having an air inlet mouth and associated therewith front surfaces facing forwardly for directing incoming wind through the mouth in an inlet direction;

each cell having a movable element responsive to movement of the wind through the mouth arranged such that movement of the movable element generates electricity;

the array being mounted on the upstanding face with the front surfaces facing forwardly of upstanding structure;

the cells being arranged to turn the air after entering the mouth and engaging the moving element so as to be released in a direction transverse to the inlet direction.

Preferably each cell includes guide surfaces rearward of the mouth for engaging the air and turning the direction of the air to the transverse direction.

Preferably the apparatus includes guides for the residual air to cause it to flow upward along the face.

According to a fifth aspect of the invention there is provided an apparatus for generating electrical energy from wind comprising:

an upstanding structure having an upstanding face directed toward a prevailing wind;

an array of cells each arranged for generating electricity from wind;

each cell having an air inlet mouth and associated therewith front surfaces facing forwardly for directing incoming wind through the mouth in an inlet direction;

each cell having a movable element responsive to movement of the wind through the mouth arranged such that movement of the movable element generates electricity;

the array being mounted on the upstanding face with the front surfaces facing forwardly of upstanding structure;

wherein the mouth is circular and each of the cells includes an impeller located behind the circular mouth so as to rotate about an axis at right angles to the plane of the mouth and coaxial with the mouth.

Preferably the impeller is connected to a brushless DC generator.

According to a sixth aspect of the invention there is provided an apparatus for generating electrical energy from wind comprising:

an upstanding chimney for transporting gases to an elevated location, the chimney having an upstanding face directed toward a prevailing wind;

an array of cells each arranged for generating electricity from wind;

each cell having an air inlet mouth and associated therewith front surfaces facing forwardly for directing incoming wind through the mouth in an inlet direction;

each cell having a movable element responsive to movement of the wind through the mouth arranged such that movement of the movable element generates electricity;

the array being mounted on the upstanding face with the front surfaces facing forwardly of the upstanding chimney;

the cells being arranged to turn the air after entering the mouth and engaging the moving element so as to be released in a direction upward along the chimney;

the cells being arranged such that the upward movement of the air acts to assist movement of gases upward in the chimney.

Preferably each cell includes guide surfaces rearward of the mouth for engaging the air and turning the direction of the air to the upward direction.

Preferably the apparatus is arranged such that the upward moving air mixes with the gases.

Preferably there is provided a combination of guide surfaces in front of and behind the cells to create a pressure differential between the front and the rear of the cells for driving the movable elements. These are preferably provided by the guide surfaces at the front converging to the mouth and using the Coanda effect to concentrate the airflow. Behind the cells is preferably provided a guide surface which turns the airflow emerging from the turbine to merge it with the air running up the front of the structure from below the array.

Preferably each cell includes a rear airflow deflector arranged to guide the airflow emerging from the movable element to merge the airflow with air moving upwardly of the structure behind the cells to generate a reduced pressure at the rear of the cells to assist in turning the movable elements.

Preferably the array includes a top airflow deflector arranged to guide the airflow emerging from the array to merge the airflow with air moving across a top of the structure to generate a reduced pressure at the rear of the cells to assist in turning the movable elements.

The present invention features an electrical generating system to be directly mounted on structures such as the exterior walls of high buildings. This concept is based on a small wind cell that can be multiplied in wind panels and arrays in a similar mode with solar cells. The main reason for this approach is the fact that wind speed and consequently wind pressure is rarely uniform on large input areas which are used by wind turbines to harvest its kinetic energy and convert it into electric power. Large turbines are actually integrating the wind energy on the input area in the plane of rotation at mechanical level. This is one reason for having the well known Betz limit of their efficiency.

Nature taught us so many times that power is in numbers. So the idea of creating a wind cell small, light and cheap enough to be the basic structure of wind panels and arrays that can be easily integrated as architectural elements for covering the exterior walls of buildings is coming from that direction. The wind cell has two key advantages: having a small and light rotor, responds very fast to wind speed changes converting it in electric energy at a very low level of sound and vibration. In this case, the integration of wind changes is done at electrical level as all wind cells in a panel are charging a battery. As a bonus, this concept has a side-effect with major implications in the design of building structures: it reduces significantly the wind pressure on the windward wall itself. In the back of any wind turbine, the wind speed is much lower than in front of it but no wind turbine was mounted against a wall to use this effect.

The invention therefore provides an electrical energy generating system for being directly mounted on the exterior walls of high buildings which comprises a ducted shroud facing the wind and concentrating its flow to a plurality of small centrifugal turbines connected to preferably brushless DC generators. After driving rotation of the turbines, the residual air exits each turbine axially and flows along the wall after being directed through Coanda effect by a deflector. Finally, the residual air which flows preferably upward along the wall is discarded at the edge of the roof where another deflector creates a negative pressure helping the residual airflow to gather the wind blowing over the roof. While each wind cell generates only a few tens of watts, a whole array of cells covering a structure such as the windward walls of a building can generate a large amount of electricity to be used for cutting the energy costs of that building and/or to be made available to a broader energy grid.

Since a wind array converts a significant percentage of the kinetic energy of the wind into electricity and in that process redirects the residual airflow to a perpendicular plane in respect to the wind direction, then the wind pressure on the wall of the building is significantly reduced. For a new building, integrating wind arrays could mean a recalculation of the maximum wind-load and a downsizing of the structure and its cost.

A wind array produces electric power without generating noise and vibrations like large roof-mounted wind turbines and does not imply the reshaping of the building for concentrating the wind flow to large inbuilt turbines. Due to its modular cell-structure, a wind array harvests the wind energy more extensively than a large turbine which cannot integrate all the non-uniformities of wind pressure on the input surface.

This concept is particularly applicable to tall buildings, chimneys and offshore platforms but can be applied to fixed structures such as self-powered billboards, cliffs in coastal regions, and to movable structures such as blimps and other forms of airships, ship deck structures etc.

In most cases it is desirable to mount the array so that it allows the air released behind the array to be mixed with airflow over the structure so that the mixing of the airflow from the array with the airflow over the structure generates a reduced pressure across the cells of the array. Thus in most cases the array is mounted at a top of the structure to allow the airflow over the structure to mix with the airflow through the array. In respect of an off-shore platform therefore the array will generally be mounted adjacent the top of the platform rather than on the legs of the platform.

In respect of a chimney, the array will generally be mounted at the top of the chimney as a top cap. On an existing chimney the array can be added on top of the existing structure to add further height so that the airflow can cooperate with the top of the cap at the top of chimney to utilize the cooperation of the airflows to create the reduced pressure. In some cases the airflow from the array is mixed with the flow of gases in the main part of the chimney to assist the upward flow of the gases to a further increased height. In other cases the cap forming the array keeps the airflow separate from the gases up to the point where the airflow is released at the top of the cap.

According to a second aspect of the invention there is provide an apparatus for generating electrical energy from wind comprising:

at least one cell having associated therewith front wind guide surfaces for directing incoming wind through a mouth;

the or each cell having a movable element responsive to movement of the wind through the mouth arranged such that movement of the movable element generates electricity;

the or each cell being arranged for mounting on a structure for facing a prevailing wind;

the or each cell including an airflow deflector arrangement arranged to guide the airflow emerging from the movable element to merge the airflow with air moving along the structure so as to generate a reduced pressure at the rear of the cell to assist in turning the movable element.

Preferably the airflow deflector arrangement includes a member behind the cell to guide the airflow emerging from the movable element to merge the airflow with air moving upwardly of the structure behind the cells.

Preferably the airflow deflector arrangement includes, in addition or as an alternative, a member at a top of the structure to guide the airflow to merge the airflow with air moving across a top of the structure.

In all cases the surfaces are curved so as to use the Coanda effect and the venturi effect so that the air flow over the structure passes over an opening at which the air from the cell or cells is released so that the air flow over the structure generates a reduced pressure at the opening thus drawing the air from the cell and thus generating a pressure difference across the cell.

In the case of a building or other similar structure having a closed exterior surface, the air flow over the structure is guided relative to the cells of the array along the exterior surface. In the case of a chimney, the air flow may be the flow of exhaust gases and air within the interior of the chimney. In this case the array can be used to extract energy from the moving gases in the chimney.

### BRIEF DESCRIPTION OF THE DRAWINGS

Embodiments of the invention will now be described in conjunction with the accompanying drawings in which:

FIG. 1 is an isometric view of a single cell of a first embodiment of an apparatus according to the present invention.

FIG. 2A is an isometric view of an array of the cells of FIG. 1 from the front and one side.

FIG. 2B is an isometric view of the array of FIG. 2A from the rear and one side.

FIG. 3 is a side view of the array of FIG. 2A.

FIG. 4 is an isometric view of the array of FIG. 2A showing the construction at the roof of a building.

FIG. 5 is a side elevational view of self powered billboard using the array of the cells of FIG. 1.

FIG. 6 is an isometric view of an alternative form of cell of a further embodiment of the invention.

FIG. 7 is an isometric view from the front and one side of the array of the cells of FIG. 6.

FIG. 8 is a horizontal cross-sectional view of an array defined by a single row attached to a top of a structure.

FIG. 9 is a view similar to that of FIG. 8 which uses the flow over the top of the structure only for generating a reduced pressure on the downstream side of the impeller

FIG. 10 is a front elevational view of an array in the form of a cap attached to a chimney where air emerging from the rear of the turbine is mixed with gases flowing in the chimney.

FIG. 10A is an enlarged portion of FIG. 10.

In the drawings like characters of reference indicate corresponding parts in the different figures.

### DETAILED DESCRIPTION

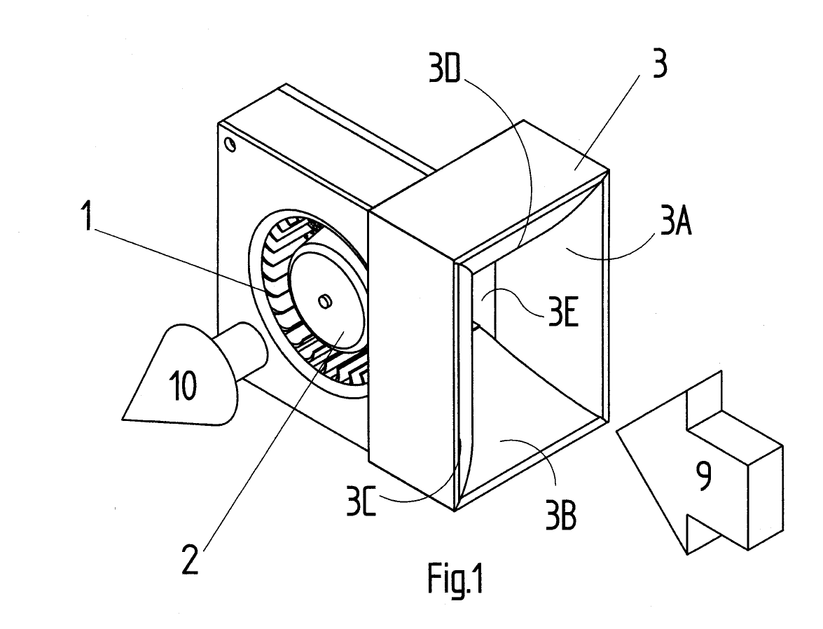

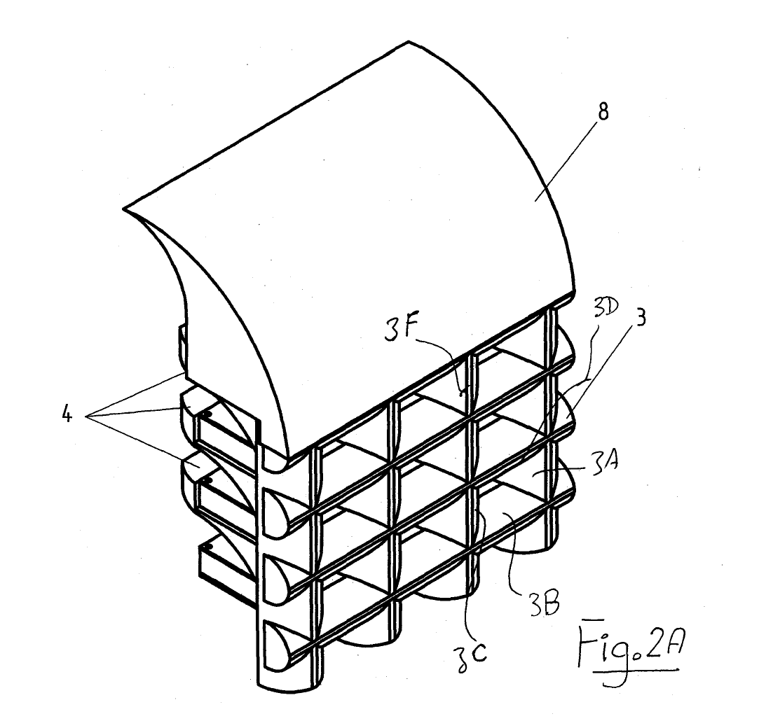

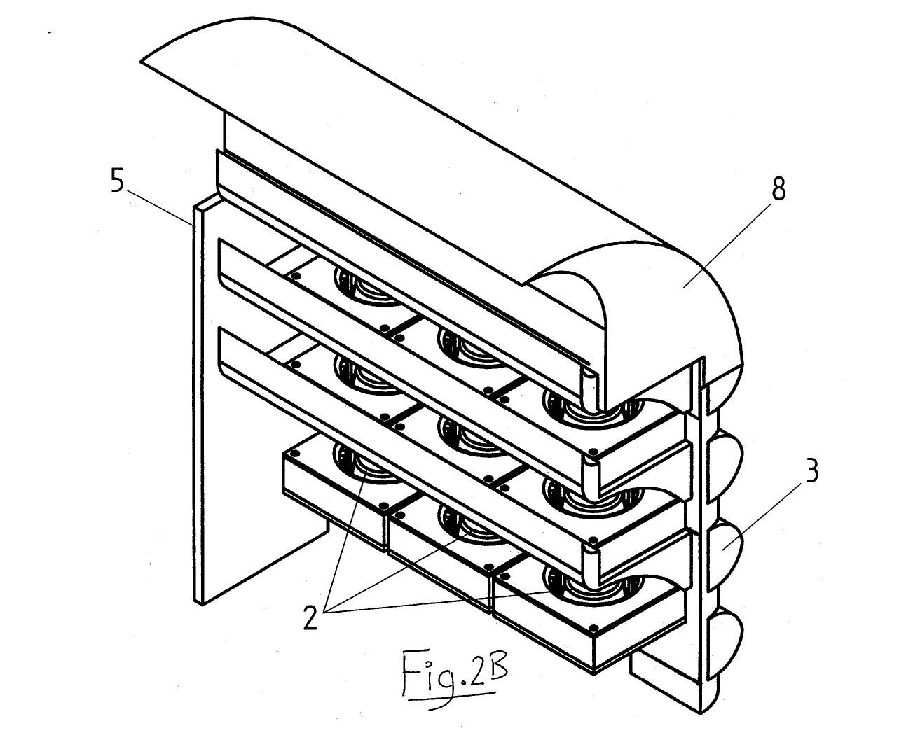

A preferred embodiment of a wind cell according to the invention is shown in FIG. 1. A centrifugal micro turbine 1 drives an electrical generator 2 when wind blows through a shroud 3. From the airflow point of view, the centrifugal turbine has a tangential input 9 and an axial output of residual air 10. That is, the turbine has a series of angularly spaced blades arranged in a cylindrical pattern around the axis of rotation of the turbine with an open area inside an inside edge of the blades. Each blade extends parallel to the axis and is inclined so that air impinging on the blade is directed from the blade radially inwardly into the interior of the turbine into the open area while applying a force to the blades to cause rotation of the turbine. As conventionally, the blades are curved so that the air is smoothly turned from the initial point of impact on a generally tangential line inwardly toward the open inner area while applying the turning force on the blades and thus on the rotor of the turbine. The air entering the interior of the turbine turns to an axial direction 10 where it escapes from one open axial end 1B of the turbine. The other end is closed thus forcing the air in the axial direction through the open end. The electrical generator is preferably a DC brushless, ironless, permanent magnet type. The array of cells is arranged for generating electricity from wind where each cell has four converging wind guide surfaces 3A, 3B, 3C and 3D for directing incoming wind through a mouth 3E between the surfaces associated with that cell. Each cell has a movable element responsive to movement of the wind through the mouth arranged such that movement of the movable element generates electricity. In the embodiment shown in FIGS. 1, 2A and 2B this comprises a turbine. The cells are connected in the array side by side in rows and columns such that the guide surfaces present a front face or shroud 3 in front of a portion of the front surface 6 of the building or other structure so that the array covers the front face for presentation to the wind with the movable elements behind the front face. Thus the turbines are mounted with their axes of rotation generally parallel to the plane of the mouths and offset to one side of the mouth such that the wind passing through the mouth enters into the generally cylindrical turbine while generating a rotational force on the turbine and exits the turbine in a generally axial direction.

The turbine of each cell is arranged to release residual air in a direction 10 generally at right angles to or transverse to the incoming direction 9 so as to be directed along the front face 6 of the upstanding building or other structure.

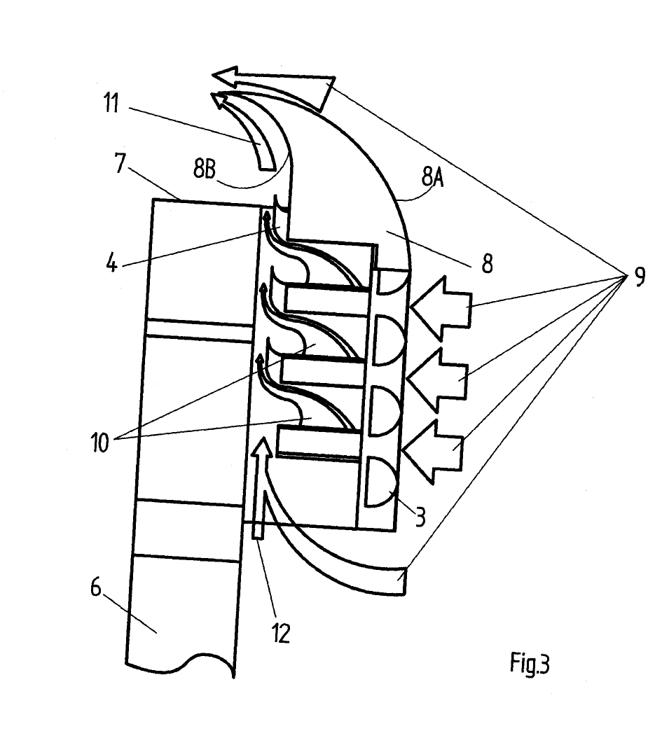

In FIG. 1 the cell is shown with the axis of the turbine horizontal and the air emerging along the direction 10 which is horizontal. However it will be appreciated that the turbines may also be arranged with the axis vertical as shown in FIGS. 2A, 2B and 3 where the direction of release of the air is vertically upwardly.

The guide surfaces are shaped and arranged to direct the wind through Coanda effect so that the air impacting the front nose 3F of the surfaces between two of the cells is guided to divide and follow the surfaces and flows smoothly with the surfaces to the mouth 3E to smoothly enter the mouth 3E.

The turbine is connected to a brushless DC generator 2 of a type commonly used in simple motors but in this case is used in reverse as a generator.

The turbine 1 is mounted with an axis of rotation parallel to the front wall 6 of a structure and parallel to a common plane of the mouths 3E and, after driving rotation of the turbines, the residual air exits each turbine axially and flows along the front wall 6 of the structure. The mouth 3E is offset from the axis 1A of the turbine so that the air enters the interior of the generally cylindrical turbine while acting to rotate the blades of the turbine and exits axially at reduced velocity and pressure.

Each wind cell generates only a few tens of watts, which energy is connected from a whole array of cells covering a front wall 6 of the structure to generate a large amount of electricity to be used for cutting the energy costs of that structure and/or to be made available to a broader energy grid. The front wall selected is of course that wall which is primarily a windward wall or more than one wall may be used to carry the array.

The shroud 3 and its guide walls converging to the mouth is basically a wind concentrator designed to enhance the efficiency of the turbine. The shroud includes the four walls guiding the air from four sides of the cell so as to enter the opening or mouth through which the air enters and is directed to impinge on the turbine. The opening 3E is rectangular with one side at the exit end of each wall. The walls are shaped with the curvature designed and arranged to provide improved efficiency when the wind is not at right angles to the plane of the mouth and therefore to the wall 6 and particularly at wind angles in the range of +/−45 degrees in respect to the perpendicular direction to the turbine, both in vertical and horizontal planes. This is achieved by making the airflow to follow the shape of the wall or shroud surface 3A, 3B, 3C and 3D due to Coanda effect.

The same effect is further exploited for the management of residual air in the back of the wind cells associated in a wind panel or array as shown in FIG. 2A and FIG. 2B where the air released upwardly from the turbines along the directions 10A is guided over a curved guide surface 10B.

Because most of the time, the exterior walls of high buildings receive an upward air current generated by the difference in temperature of the air at ground level and at roof level respectively, the preferred embodiment of the wall mounted wind panel or array is arranged with the air from the cells directed from the interior of the turbines guided to exit the residual air in the same direction to the roof.

In reference to FIG. 2A, FIG. 2B and FIG. 3, a plurality of wind cells are mounted in a matrix to form a wind panel or array of rows and columns that is wall mounted using a series of vertical spacers 5 which connect from the array rearwardly to the front wall 6. The residual air 10A from a row of wind cells is directed by a back deflector 4 or collector at the rear of the surface 10B to direct that residual airflow along the wall 6 up to the roof 7 where another edge deflector 8 curves from a vertical direction to a horizontal direction across the roof. This deflector 8, with a front curved surface 8A engaging the impinging air stream 9 and a rear curved surface 8B engaging the air stream 10C along the front wall, acts to generate a negative pressure that sucks the residual air 11 coming from all rows in a panel between two spacers 5 and join it to the wind 9 blowing over the roof which follows the front curvature 8A of the edge deflector 8. The ground air 12 rising along the front of the building below the bottom of the arrays also merges with the incoming wind 9 to help in creating the suction of the residual air 10 to be evacuated at the roof edge. The efficiency of each micro turbine is proportional to the air pressure differential between the front and the back of the turbine and this pressure differential is enhanced by the above air streams which act to increase the flow 10.

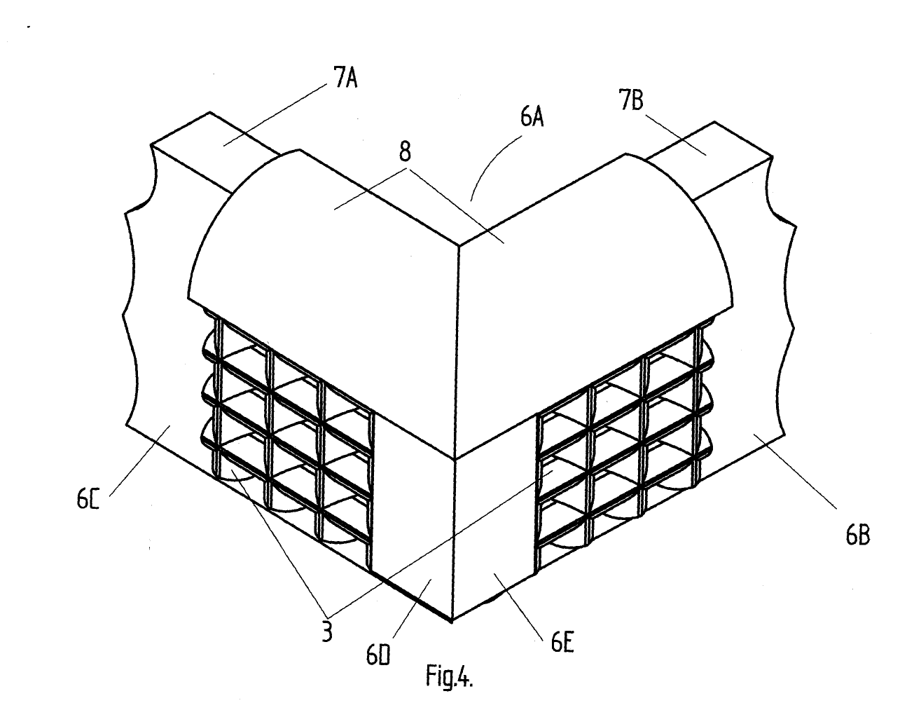

FIG. 4 shows how two wind arrays are mounted at a corner 6A between two walls 6B and 6C and horizontal roof edges 7A and 7B of a building and the associated shrouds 3 and wind deflectors 8. The arrays may cover the whole of the walls or may be limited to an area adjacent the roof 7. The arrays at the corner are separated by corner face plates 6D and 6E in front of the wall 6 and arranged at the front of the guide shrouds 3. Each turbine is housed in its own housing 1C with the only opening being defined by the inlet mouth 3E and the outlet 2B.

Typically each turbine may have a rotor diameter of the order of tens of centimetres and may generate power in the range 10 W to 1 KW. An array may include a number of turbines in the range tens to thousands. The shroud of each cell may have a front opening of the order of hundreds of square centimetres up to 4-5 square meters and a mouth of the same order of magnitude. It is expected that approximately 10 to 40% of a wall might be covered by the arrays. Typically the arrays will start at a distance of at least 30 meters from the ground and cover the upper part of the wall. Such an arrangement may generate megawatts of electric power of a high tower building, depending on the particular outer shape and size of the structure.

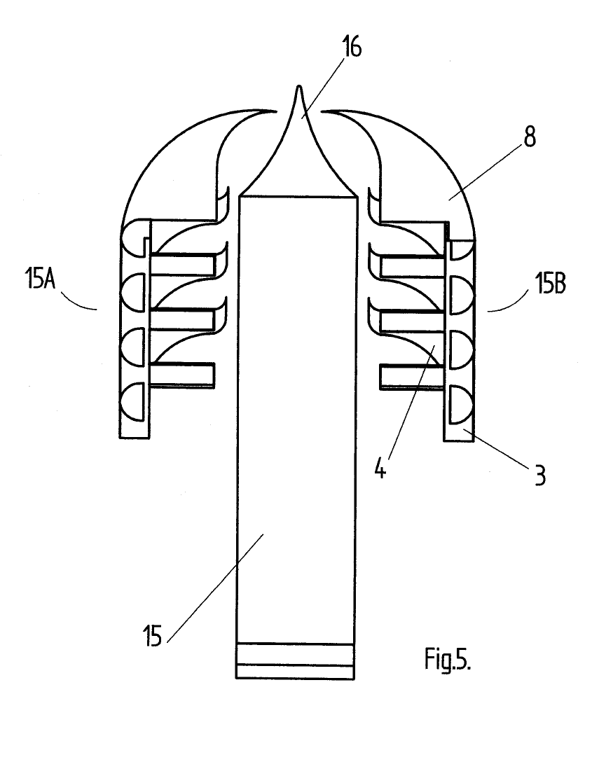

Another application of the present invention is in self-powered billboards. The vertical structure 15 of a billboard can be covered with two back-to-back wind panels or arrays 15A and 15B, as shown in FIG. 5. In this case, a central deflector 16 which receives the air from the two deflectors 8 is symmetrically reshaped for helping the residual air to exit at the top of the structure from both sides. Due to the wind pressure reduction mentioned before, the billboard can withstand high winds and at the same time generates the electric power for illuminating the board. The advertising message that any billboard is displaying can be actually painted on the shrouds 3 and from a distance the holes and lofted cuts are not visible. Another option for illumination is to use bright LEDs embedded into the shrouds 3. When electric energy is available for stand-alone billboards due to the application of wind arrays, then any kind of light emitting display can be utilized.

The same structure as used for the billboard described above can be built for electric power generation in coastal regions where the night and day breezes have opposite but constant directions.

Deck structures on surface vessels and offshore oil and gas drilling platforms also face high winds most of the time. Mounting wind panels on their vertical walls can contribute to decrease the fuel consumption involved in electric power generation, lowering their cost of operation.

Another application of the present invention is addressed to powering large airships such as helium aircrafts. The wind arrays can be made extremely light if most of their components are made of polyurethane, carbon fibers or composite materials. Beside the power generation, the drag reduction effect can be a key element in improving the control over the aircraft, especially in high altitude hovering applications as telecommunications relay platforms. In this particular application, the residual air can be made to exit downward for adding to the lift force or in any other useful direction. The weight to power ratio of airborne wind arrays can successfully complement the existing systems making possible to lift and power larger payloads for an extended period of time.

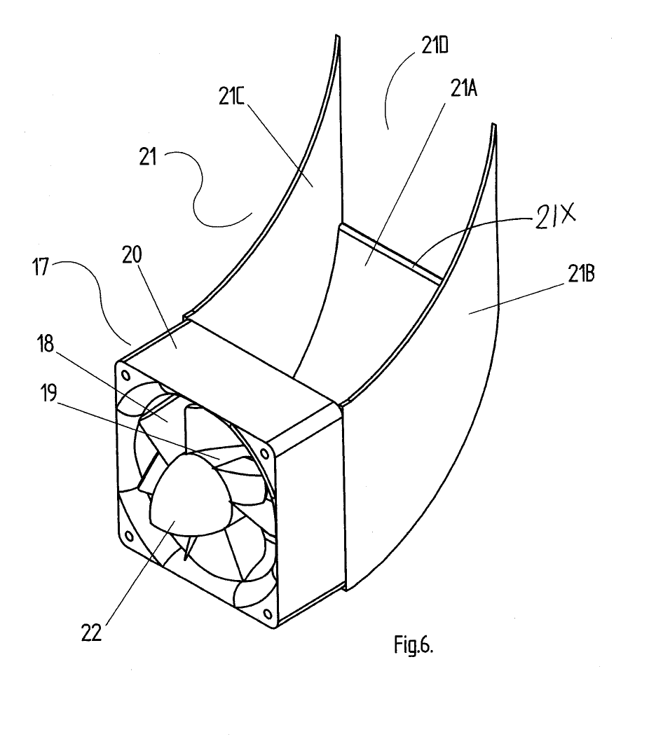

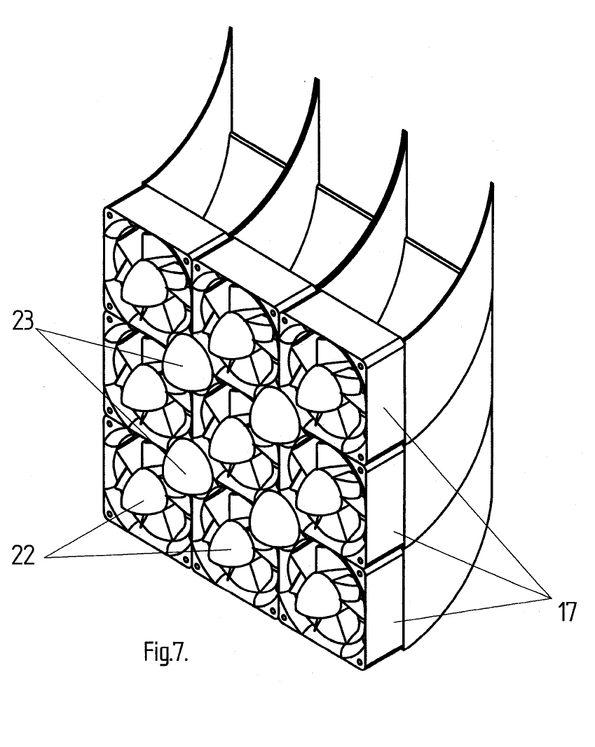

Turning now to the embodiment shown in FIGS. 6 and 7, the cylindrical turbine type rotor is replaced by an impeller type rotor having a hub 19 and blades 18 surrounding the axis of the hub. Thus in this embodiment, the mouths of the array through which the air is guided to pass are circular with the impeller behind the mouth rotating about an axis at right angles to and coaxial with the mouth and facing the intended direction of the incident wind. The mouth is mounted in a rectangular housing 20 so that the housings can be mounted in rows and columns side by side. Behind each housing is mounted an air guide chute 21 which has a square front face butting the rear of the housing and a curved guide surface 21A which commences at one edge and curves rearwardly and to one side to turn the air to a direction at right angles to the incident direction along the axis of the mouth and of the impeller. Two of the edges are connected to side walls 21C and 21B which confine the air into the chute to turn the air to travel along the front surface of the wall on which the array is mounted. The chutes are shaped with a cut out portion 21D between the side walls so that the chutes can be mounted side by side and one above the other in the array.

It will be noted that the surface 21A has an edge 21X which is spaced from the surface of the structure or building behind the cell. Thus the air moving along the structure upwardly of the cell passes over this edge to the opening above this edge where the air from the cell is located. The Coanda effect and/or the venturi effect on the air behind the surface 21A thus generate a low or reduced pressure at the edge 21X acting to draw the air of the cell upwardly and rearwardly to generate a reduced pressure in this air.

A guide nose 22 is mounted on the front of the hub to rotate with the hub and so as to assist in guiding the air around the hub and onto the blades.

The hub contains a brushless DC generator which rotates relative to a shaft on which the hub is mounted to generate electric energy as previously described.

When a plurality of axial wind cells are assembled in a matrix, a wind panel or array is obtained. The isometric front and rear views of such a panel or array are shown in FIG. 7. Noses 23 smooth the airflow at the corners of four neighbouring wind cells and are mechanically connecting the walls defining the cells.

Both centrifugal and axial wind cells have to be mounted at some distance from the windward or front wall using spacers, in order to allow the creation of a lower (negative) air pressure behind the array of micro-turbines than the wind pressure (positive) in front of the array. The higher the difference between the two air pressures, the higher the efficiency of the wind cells. The upward airflow along the wall of the structure and the top edge deflector are important in creating a desirable suction of the air behind the micro-turbines to increase efficiency.

The wind cell converts the linear momentum of the incoming wind into a rotational momentum and further into the output electric energy. Because the above mentioned conversion of energy is not 100% efficient, some residual linear momentum of the wind remains which acts as a pressure on the supporting structure of the array which is transferred to the wall behind the array of wind cells by the structure mounting the array on the wall. However, the initial wind pressure on the windward wall of a building is significantly reduced by the presence of the arrays. This means that for already existing buildings the maximum wind load is upgraded and, for any future high structure incorporating wind panels or arrays, the construction can potentially be lighter and cheaper while still complying to existing building codes.

For all the embodiments, excepting the permanent magnets, shaft, bearings and coils of the generators that have to be metallic in nature, all the other building parts of the wind cells and arrays can be made of polyurethane, carbon fiber, composite materials or even Styrofoam. Airborne or not, the wind panels or arrays have to be as light and cheap as possible. Their modular structure is also an asset when thinking of manufacturing, assembling or servicing.

A further special application of the present invention is the enhancement of the chimney effect used for power generation.

Thus the concepts are used with an upstanding chimney for transporting gases to an elevated location, the chimney having an upstanding face directed toward a prevailing wind. In this embodiment, the array of cells is mounted with the front surfaces facing forwardly of the upstanding chimney. The cells are arranged to turn the air after entering the mouth and engaging the moving element by the guide surfaces rearward of the mouth engaging the air and turning the direction of the air to the upward direction. In this way with the upward moving air arranged to mix with the gases in the chimney so as to be released in a direction upward along the chimney, the upward movement of the air acts to assist movement of gases upward in the chimney. Both basic concepts of wind cells described hereinbefore can be applied for building a top section and a base section of a circular chimney-tower. The wind panels and arrays described hereinbefore are arranged as wall mounted constructions. However it will be appreciated that, for example in the chimney arrangement, the arrays may not necessarily be wall mounted but can be formed so as to form a structural element defining the wall itself.

The electrical energy generated by wind panels and arrays has to be temporarily stored or buffered and conditioned to match the load. This can be done in many possible ways known to persons skilled in the art, using automatic chargers, batteries, super-capacitors and inverters similar or identical to those used in photovoltaic industry.

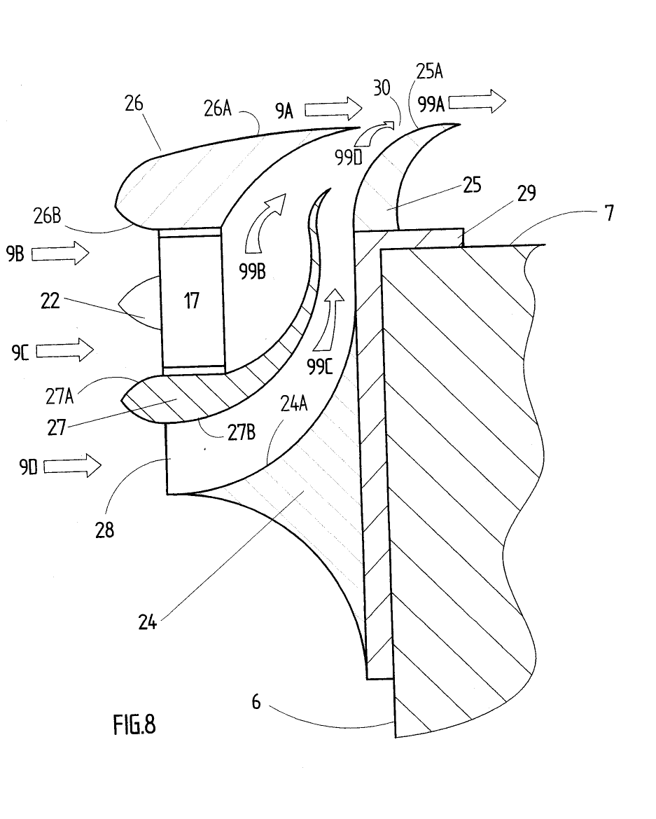

In FIG. 8 is illustrated another embodiment of the invention in a cross section view which incorporates an impeller-type turbine 17 surrounded by a number of specially shaped air deflectors 24 to 27 designed to split, channel and guide through Coanda effect the incoming wind into flows 9A to 9D. Flows 9B and 9C are channelled into the turbine 17 by surfaces 26B and 27A and the nose 22. At the same time, the flow 9D is “trapped” into the air-intake 28 created below the turbine through surfaces 27B and 24A and is transformed into flow 99C that further on creates a first suction force attracting and merging with the flow 99B exiting the turbine. A second suction force is generated by the flow 9A guided by surfaces 26A and 25A over the opening 30, attracting and merging with flow 99D into flow 99A. The purpose of this design is to maximize the pressure differential on both sides of the turbine by concentrating the entering wind and absorbing the exiting air. As the wind energy is the only available source, this embodiment makes possible to use it for three simultaneous actions to generate a high positive pressure in front of the turbine in one stage and a low negative pressure behind it in another two stages. In fact, what drives the turbine is the pressure differential between input and output. The arrangement in FIG. 8 provides an array which has a single row of turbines. However it will be appreciated that one or more additional rows could be added below the single row with the intake wall 24 below the lowermost row.

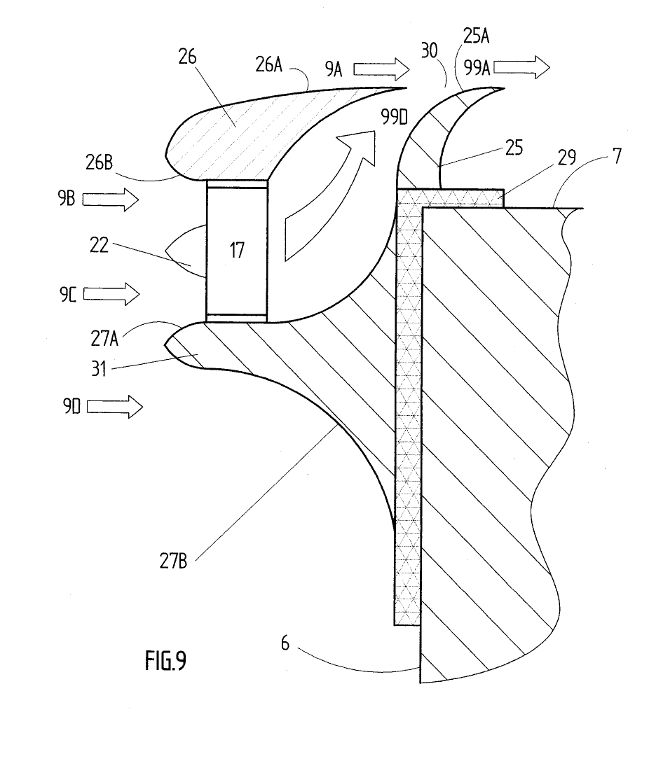

In FIG. 9 is shown a simplified version of the wind cell of FIG. 8 in which the suction force is generated in only one stage. Deflectors 24 and 27 are combined into deflector 31 and the exiting turbine flow 99D is extracted by and merged with flow 9A into flow 99A over the top 7 of the structure. In this embodiment the air flow along the wall of the structure is not used and is instead guided to a position in front of the row or rows of array by the surface 27B.

Both embodiments of FIGS. 8 and 9 are hung on a wall 6 at the top front edge 7 of a structure through the support 29 in preferably one-row array. Multi-rows arrays are also possible to be built, in which case deflectors 24, 27 and 31 have to be mounted on a different support that is spaced from the wall 6 to accommodate an air duct for the upward flow, similarly to FIGS. 1-7.

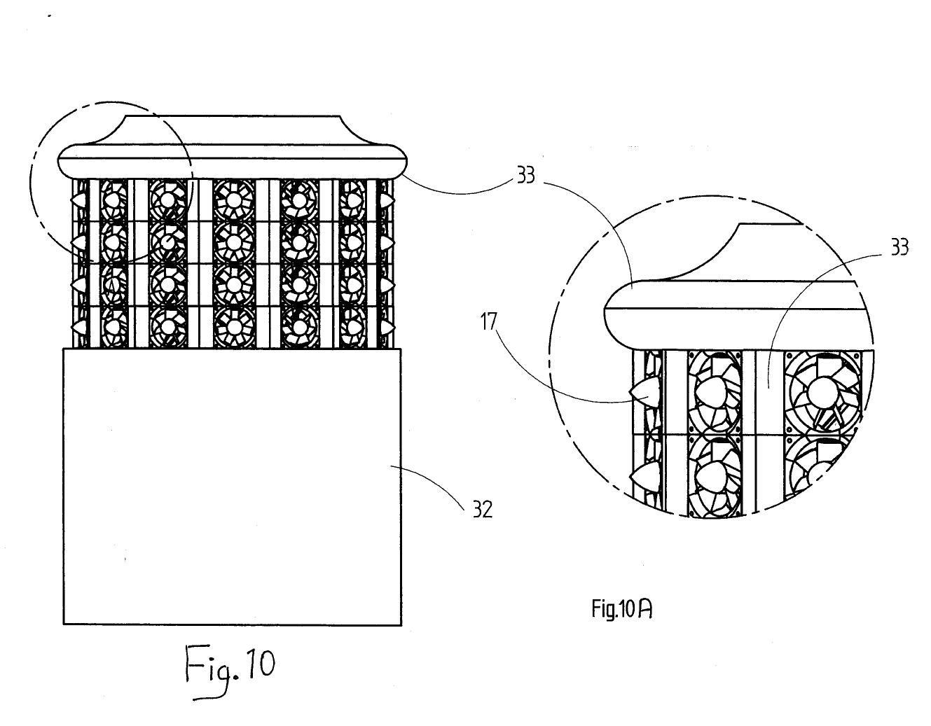

In FIG. 10 is shown a curved array of wind cells in the form of a cap to be mounted on the top of a chimney. In this configuration the rear wall is missing and turbines are driven by the suction generated by the chimney interior up-flow. Additionally, when wind is blowing in one direction, wind cells facing that wind are also driven by the front high pressure. Wind cells 17 are angularly fastened with spacers 34, the array being mounted on the top of the chimney 32 and terminated with a top deflector 33.

In the case of chimney and referring to the arrangement shown in FIG. 6, the surface 21A is mounted on the chimney so as to project into the cross-section of the chimney to be presented into the upwardly moving gas flow in the chimney. Thus the gases are diverted inwardly and upwardly by the surface 21A and flow over the rear surface to reach the edge 21X. This movement of the gases thus generates a low pressure acting to draw air through the impeller regardless of the presence of wind or the direction of the wind on the exterior of the impeller.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for generating electrical energy from wind comprising:
an array of cells each arranged for generating electricity from wind;
each cell having associated therewith wind guide surfaces for directing incoming wind through a mouth;
each cell having a movable element responsive to movement of the wind through the mouth arranged such that movement of the movable element generates electricity;
the array being arranged for mounting on a structure for facing a prevailing wind.

2. The apparatus according to claim 1 wherein each cell is arranged to release residual air in a direction transverse to the incoming direction so as to be directed along a front face of the structure.

3. The apparatus according to claim 1 wherein the cells are connected in the array side by side such that the guide surfaces present a front face for presentation to the wind with the movable elements behind the front face.

4. The apparatus according to claim 3 wherein the guide surfaces of each cell interconnect with guide surfaces of next adjacent cells to present a front face of the surfaces between the cells.

5. The apparatus according to claim 1 wherein the apparatus is arranged to be directly mounted on one or more exterior walls of a high building.

6. The apparatus according to claim 1 wherein the guide surfaces form a ducted shroud facing the wind and concentrating its flow to each of the cells.

7. The apparatus according to claim 1 wherein the guide surfaces are arranged to direct the wind through Coanda effect.

8. The apparatus according to claim 1 wherein each of the cells comprises a small centrifugal turbine.

9. The apparatus according to claim 8 wherein the turbine is connected to a brushless DC generator.

10. The apparatus according to claim 1 wherein, after driving rotation of the turbines, the residual air exits each turbine axially of the turbine and flows along a front face of the structure.

11. The apparatus according to claim 1 wherein the apparatus includes guides for the residual air to cause it to flow upward along a front face of the structure.

12. The apparatus according to claim 11 wherein the guides for the residual air are arranged to receive the air from a plurality of the cells arranged in a row across the structure.

13. The apparatus according to claim 12 wherein the residual air is discharged at a top edge of the structure.

14. The apparatus according to claim 13 wherein a top deflector is shaped to receive upwardly moving air and to redirect it into a horizontal flow over a top of the structure.

15. The apparatus according to claim 14 wherein the top deflector is shaped to create a negative pressure in the residual airflow.

16. The apparatus according to claim 1 wherein each wind cell generates only a few tens of watts which energy is collected from the array of cells.

17. The apparatus according to any claim 1 wherein the array is mounted on the upstanding face of an upstanding structure and the cells are arranged such that movement of the movable element causes generation of a residual airflow at a velocity and pressure less than that of the incoming wind with the residual airflow being released in front of the face of the structure and behind the guide surfaces so as to reduce a pressure on the face from the incoming air.

18. The apparatus according to claim 1 wherein each cell comprises a small, centrifugal, generally cylindrical turbine responsive to movement of the wind through the mouth to drive the turbine about its axis and connected to a DC generator to generate electricity; wherein the turbines are mounted with their axes of rotation generally parallel to the plane of the mouths and offset to one side of the mouth such that the wind passing through the mouth enters into the generally cylindrical turbine while generating a rotational force on the turbine and exits the turbine in a generally axial direction.

19. The apparatus according to claim 1 wherein the mouth is circular and each of the cells includes an impeller located behind the circular mouth so as to rotate about an axis at right angles to the plane of the mouth and coaxial with the mouth.

20. The apparatus according to claim 19 wherein the impeller is connected to a brushless DC generator.

21. The apparatus according to claim 1 wherein the upstanding structure comprises an upstanding chimney for transporting gases to an elevated location, the array being mounted on chimney with the front surfaces facing outward of the upstanding chimney, the cells being arranged such that air emerging from the rear of the cells is mixed with air flowing upwardly in the chimney.

22. The apparatus according to claim 1 wherein there is provided a combination of guide surfaces in front of and behind the cells to create a pressure differential between the front and the rear of the cells for driving the movable elements.

23. The apparatus according to claim 1 wherein each cell includes a rear airflow deflector arranged to guide the airflow emerging from the movable element to merge the airflow with air moving upwardly of the structure behind the cells to generate a reduced pressure at the rear of the cells to assist in turning the movable elements.

24. The apparatus according to claim 1 wherein the array includes a top airflow deflector arranged to guide the airflow emerging from the array to merge the airflow with air moving across a top of the structure to generate a reduced pressure at the rear of the cells to assist in turning the movable elements.

25. The apparatus according to claim 1 wherein the array comprises a single row of cells at the top of the structure.

26. Apparatus for generating electrical energy from wind comprising:
at least one cell having associated therewith front wind guide surfaces for directing incoming wind through a mouth;
the or each cell having a movable element responsive to movement of the wind through the mouth arranged such that movement of the movable element generates electricity;
the or each cell being arranged for mounting on a structure for facing a prevailing wind;
the or each cell including an airflow deflector arrangement arranged to guide the airflow emerging from the movable element to merge the airflow with air moving along the structure so as to generate a reduced pressure at the rear of the cell to assist in turning the movable element.

27. The apparatus according to claim 26 wherein the airflow deflector arrangement includes a member behind the cell to guide the airflow emerging from the movable element to merge the airflow with air moving upwardly of the structure behind the cells.

28. The apparatus according to claim 26 wherein the airflow deflector arrangement includes a member at a top of the structure to guide the airflow to merge the airflow with air moving across a top of the structure.
